(19) United States
(12) Patent Application Publication
(10) Pub. No.: US 2006/0119136 A1
(43) Pub. Date: Jun. 8, 2006

(54) METHOD OF MANUFACTURING A SCORED VEHICULAR PANEL AND ARTICLE MADE THEREBY

(75) Inventors: Richard James Trombley, Clarkston, MI (US); Kenneth John Hodges, Oxford, MI (US); David Frank Turczynski, Highland, MI (US); Thomas William Spanos, Chesterfield, MI (US); David James Dooley, Troy, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/904,903

(22) Filed: Dec. 3, 2004

(51) Int. Cl. B60J 5/00

(52) U.S. Cl. 296/187.03

(57) ABSTRACT

A method and apparatus for manufacturing a vehicular panel (10) with a region of weakness that permits the panel to deform at predefined locations in a prescribed manner in response to an incident force (F). The panel (10) has a substrate with an exposed surface (“A”) side (14), a hidden surface (“B”) side (12), and a core section (16) extending therebetween. The method comprises the steps of (I) molding the part; (II) optionally, curing the part; (III) placing the part in a holding fixture; (IV) securing the “A” surface opposite an area of the “B” surface in which a scoring step is to be performed; (V) applying a scoring tool to the “B” surface to define a scored part with one or more notches (18) that extend inwardly from the “B” surface into the core section so that the one or more notches are invisible when viewed from the “A” side of the part; and (VI) retracting the tool and removing the scored part from the fixture. The one or more notches 18 extend inwardly from the hidden surface side into the core section so that they are invisible when viewed from the exposed surface side of the panel. The notches provide an engineered region of weakness in the panel so it may deform at predefined locations in response to the incident force that strikes the panel from the hidden surface side. The invention includes the vehicular panel made thereby.

### BACKGROUND OF THE INVENTION

1. Field of the Invention

The invention relates to a method of making a vehicular panel having predetermined fault lines that represent engineered points of weakness, the selectively weakened panel made thereby, and a manufacturing apparatus for practicing the disclosed method.

2. Background Art

Federal motor vehicle safety standards include regulations to which manufacturers of motor vehicle and equipment items must conform and certify compliance. At least comparable standards exist in Europe. The Federal safety standards define minimum safety performance requirements for motor vehicles and for items of motor vehicle equipment. Their purpose is to protect the public against unreasonable risk of crashes occurring as a result of the design, construction or performance of motor vehicles. Further, the requirements are also specified to protect the vehicle occupant against unreasonable risk of death or injury if a crash does occur. One regulation concerning crashworthiness relates to side impact protection (Standard No. 214). That standard specifies performance requirements for the protection of occupants in side impact crashes. Its purpose is to reduce the risk of serious and fatal injury to occupants of passenger cars, multi-purpose passenger vehicles, trucks, and buses.

In general terms, the standard requires that vehicle doors must provide resistance to a load applied under test conditions. Further, test dummies in a vehicle must meet certain requirements when the stationary vehicle is impacted by a deformable barrier at a given speed, similarly to an intersection crash.

One approach for complying with such regulations is illustrated in U.S. Pat. No. 5,431,435. That reference discloses a door trim panel that includes a cover assembly for concealing an air bag restraint system. The flexible covering which is juxtaposed to the air bag has a single tear seam that is ruptured when the flexible covering is impacted by an inflating air bag.

Other references revealed in an investigation which preceded the filing of the present application by the following U.S. patents: U.S. Pat. Nos. 4,238,544; 4,339,487; 5,154,444; 5,082,310; 5,169,204; 5,180,187; and 5,224,732.

The prior art includes systems in which the backside of a part is scored with a laser in order to weaken the part. Such techniques, however, involve relatively high expenditures for equipment and generally limit control over notch geometry to the depth and width of the cut. There is little opportunity to create a notch with various geometric profiles and provide their attendant stress characteristics around the root of the notch.

### SUMMARY OF THE INVENTION

The invention includes a method of making a vehicular panel which has an exposed surface (“A”) side, a hidden surface (“B”) side, and a core section extending therebetween. One or more notches extend inwardly from the hidden surface side into the core section so that the notches are invisible when viewed from the exposed side of the panel. The notches provide an engineered region of weakness in the panel so that the panel may deform at predefined locations in a predetermined manner in response to an incident force that strikes the panel from the hidden surface side.

The part is molded using any of the conventional processes that are suitable for making trim panels. After the part is molded and cured, it is placed in a holding fixture that supports the part firmly on the “A” surface opposite a targeted scoring area of the “B” surface.

A means for scoring, such as a scoring tool, is applied to the “B” side of the fixture. This tool can move independently of the “B” side of the fixture so that it can moved into contact with the part after the part is placed in the fixture.

The scoring tool is pushed into the back side (“B” surface) of the part so that incisions formed thereby do not penetrate to the “A” surface of the part, thus avoiding degradation of the “A” (exposed) surface appearance.

After the scoring tool penetrates the hidden side of the panel over a desired distance, the tool is backed away from the part. The scored part is then removed from the fixture.

One result of these steps is the provision of notches in the back side of the molded part. These notches weaken the part without being seen on the “A” surface of the part. Their effect is to provide engineered, pre-scribed points of weakness in the part that facilitate compliance with standards and regulations concerning crashworthiness and occupant protection.

### BRIEF DESCRIPTION OF THE DRAWINGS

FIG. 1 is a process flow chart that illustrates schematically the main process steps (I-VI) of the process;

FIG. 2 is a cross-sectional view of a conventional panel before it is subjected to the manufacturing steps of the invention;

FIG. 3 is a cross-sectional view of a part that is retained in a fixture before contact with a scoring tool that is moved toward the “B” side;

FIG. 4 is a cross-sectional view illustrating fixture-part-tool positioning upon initial contact between the tool and the part;

FIG. 5 is an enlarged, cross-sectional view of a portion of the scored panel that is manufactured by the disclosed process; and

FIGS. 6(a-c) are enlarged cross-sectional views of alternative notch geometries.

### DETAILED DESCRIPTION OF THE PREFERRED EMBODIMENT(S)

The invention has two aspects: a manufacturing process, and the product made thereby.

1. The Method of Manufacturing

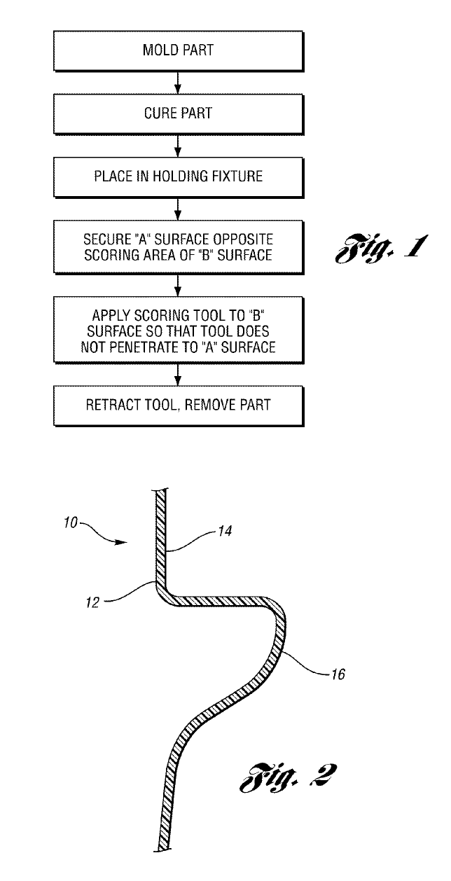

The invention includes a method for making a vehicular panel following the process steps I-VI that are depicted in FIG. 1. The process produces a panel that deforms at predefined locations in a prescribed manner in response to an impacting force that strikes the panel from its hidden (“B”) side.

For reference in understanding the process steps involved, reference is made (see, e.g., FIG. 2) to an exposed surface (“A”) side 14 of the panel, a hidden surface (“B”) side 12, and a core section 16 extending therebetween.

The main process steps (FIG. 1) include:

(I) molding the part;

(II) optionally, curing the part;

(III) placing the part in a holding fixture;

(IV) securing the “A” surface opposite an area of the “B” surface in which a scoring step is to be performed;

(V) applying a scoring tool to the “B” surface to define a scored part with one or more notches that extend inwardly from the “B” surface into the core section so that the one or more notches are invisible when viewed from the “A” side of the part;

(VI) retracting the tool and removing the scored part from the fixture.

FIGS. 2-5 include additional depictions of several of the process steps involved.

The part is molded (step I) using any of the conventional processes that are suitable for making interior trim panels. As indicated, step I involves molding a part by any suitable conventional process, including, for example, injection molding and thermoforming. The material of which the vehicular panel could be made is a thermoplastic polyolefin (“TPO”), an acrylonitrile-butadiene-styrene (“ABS”) copolymer, or a glass-reinforced-urethane (“GRU”), or a like material. After the part is molded and (optionally) cured (step II), it is placed (step III) in a holding fixture (FIGS. 2-3) that secures (step IV) the part on the “A” surface opposite a targeted scoring area of the “B” surface.

A means for scoring, e.g., a scoring tool, is applied (step V) to the “B” side of the fixture. This tool can move independently of the “B” side of the fixture so that the tool can moved into contact with the part after the part is placed in the fixture.

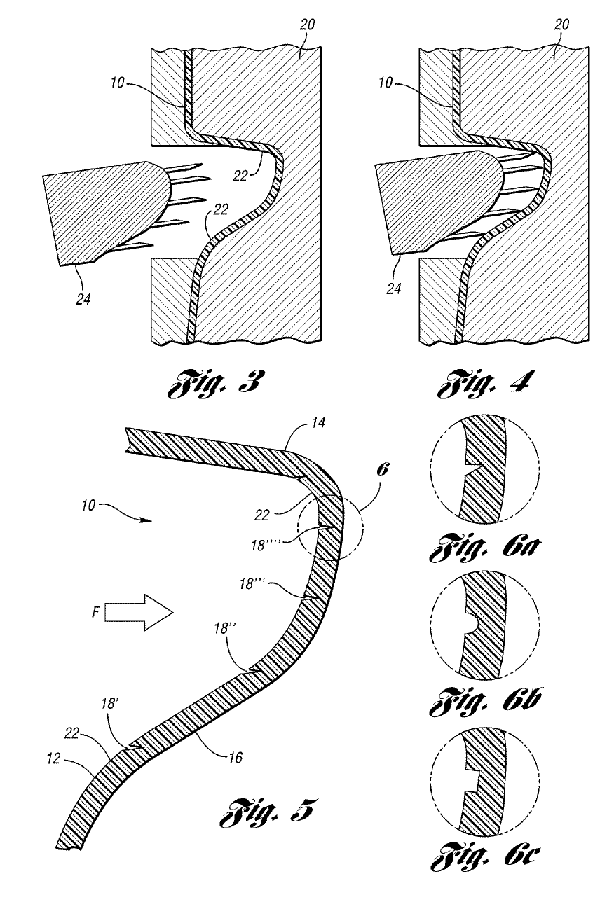

The scoring tool is pushed into the back side of the part so that incisions formed thereby do not penetrate to the “A” surface of the part, thereby avoiding degradation of the “A” (exposed) surface appearance. Preferably, one suitable scoring tool, in one alternative approach, has blades that extend from a chuck (FIG. 4). It should be appreciated that while blades are depicted in FIG. 4, their shapes should also be construed as representing ultrasonic energy emanating from a source, or a mechanical blade, knives or the like which can be vibrated. In one form, the scoring tool could be embodied in a sonic knife which traces out cuts. Such tool may be used here as in ultrasonic welding. In general, that type of tool tends to vibrate in a plane that is normal to the surface under treatment.

Alternatively, the scoring tool could be embodied in a vibration welding-type of system wherein the workpiece is secured and subjected to a relatively low frequency vibration, with the tool moving predominantly from side-to-side in relation to the workpiece.

The scoring tool can be selected so as to use ultrasonic energy, heat, and/or vibration to reduce the pressure required to penetrate into the back side of the part. If desired, manual methods for scoring the “B” surface may be used, such as use of a scoring knife, a conventional laminate scoring and cutting tool, a conventional creasing/scoring tool, and the like. Other suitable tools are available from such suppliers as Dukane and Branson.

After the scoring tool penetrates the hidden side of the panel over a desired distance, the tool is backed away (step VI) from the part. The scored part is then removed from the fixture.

One result of these steps is the provision of notches in the back side of the molded part. These notches weaken the part without being seen on the “A” surface of the part. Their effect is to provide engineered, pre-scribed points of weakness at given locations in the part that facilitate compliance with standards and regulations concerning crash worthiness and occupant protection.

What results is a part that is provided with notches in its back side and selectively weakens the part without being seen on the “A” surface. The part itself is discussed in more detail below.

The means for scoring disclosed herein each contemplate that there is little or no removal of material involved in the notch formation step which essentially is performed by local heating.

2. The Vehicular Panel

As best illustrated in FIGS. 2, 5 and 6(a-c), the vehicular panel 10 has a substrate with a hidden surface side 12, an exposed surface side 14, and a core section 16 extending therebetween. Depending upon the application, exposed surface side 14 may lie on the outside of the vehicle, or on its inside. Similarly, the hidden surface side 12 may lie on the outside of the vehicle or inside it. The vehicular panel 10 can be usefully embodied as a door trim component in the vehicle (exterior or interior), a pillar cover (mounted inside or outside the vehicle), an arm rest, or may usefully serve as an instrument panel.

As best shown in FIGS. 5 and 6(a-c), the one or more notches 18 (18′-18″″) extend inwardly from the hidden surface 12 into the core section 16. In this way, the notches 18 are invisible when viewed from the exposed surface side 14 of the panel 10.

The notches provide an engineered region of weakness in the panel so that the panel may deform at predefined locations in a predetermined manner in response to an incident force (F) that strikes the panel from the hidden surface side 12.

It will be appreciated that the notches depicted in FIG. 5 are generally V-shaped in cross-section. Various configurations (see, e.g., FIGS. 6(a-c)) of notch or groove are contemplated herein—ranging from a shallow blunt groove to a deep sharp groove, on the assumption that minimal or no form of groove is visible from the “A” surface side of the part. In one form, the notches may assume a semi-circular configuration, depending upon the means for scoring which is selected, and depending upon the desired deformation characteristics. Alternatively, a deep or shallow hyperbolic notch could be provided. In general, the purpose of the notch, without regard to its specific geometry, is to produce a stress concentration such that the panel 10 will deform in a predictable manner, preferably without rupture, and thereby avoiding minimizing the risk of injury to the vehicle occupant. In several applications, including those depicted, it should be appreciated that one contribution to stress concentration, in addition to that contributed by notches, are by fillets, radii, and surface scratches. Nominal strain may remain in the elastic region in service, but the strains are often plastic in the area of the notched roofs. Failure usually initiates those locations as localized stress is highest thereabout.

Thus, there has been described a panel that contains geometric design details that act as means for producing stress concentration.

In one embodiment, panel thickness could be between 1.5 and 5 millimeters, or preferably between 2.5 and 3 millimeters. In such cases, the depth of the notch will depend on the amount of weakness desired, but could, for example, be about 1.0-2.5 millimeters. In general, the notch may have a depth that is between 10% and 90% of the thickness of the panel.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for manufacturing a vehicular panel with a region of weakness that permits the panel to deform at predefined locations in a prescribed manner in response to an incident force that strikes the panel, the panel having a substrate with an exposed surface (“A”) side, a hidden surface (“B”) side, and a core section extending therebetween, the method comprising the steps of:
(I) molding the part;
(II) optionally, curing the part;
(III) placing the part in a holding fixture;
(IV) securing the “A” surface opposite an area of the “B” surface in which a scoring step is to be performed;
(V) applying a scoring tool to the “B” surface to define a scored part with one or more notches that extend inwardly from the “B” surface at least partially into the core section so that the one or more notches are invisible when viewed from the “A” side of the part;
(VI) retracting the tool and removing the scored part from the fixture.

2. The method of claim 1 wherein step (IV) comprises securing the “A” surface so that the area of the “A” surface that is secured is co-extensive with the area of the “B” surface in which a scoring step is to be performed.

3. The method of claim 1 wherein step (IV) comprises securing the “A” surface so that the area secured overlaps the area of the “B” surface in which a scoring step is to be performed.

4. The method of claim 1 wherein step (V) comprises applying ultrasonic energy from the scoring tool.

5. The method of claim 1 wherein step (V) comprises applying a cutting force with one or more knives.

6. The method of claim 1 wherein step (V) comprises providing one or more notches that are V-shaped.

7. The method of claim 1 wherein step (V) comprises providing one or more notches that are U-shaped.

8. The method of claim 1 wherein step (V) comprises providing one or more notches that have a rectangular profile.

9. The method of claim 1 wherein the one or more notches have a cross-sectional profile that is selected from the group consisting of a V-shape, a U-shape, a rectangular-profile, and mixtures thereof.

10. A vehicular panel comprising:
a substrate having a hidden surface side, an exposed surface side and a core section extending therebetween;
one or more notches extending inwardly from the hidden surface side into the core section so that the one or more notches are invisible when viewed from the exposed surface side of the panel,
the one or more notches providing an engineered region of weakness in the panel so that the panel may deform at predefined locations in response to an incident force that strikes the panel from the hidden surface side.

11. The vehicular panel of claim 10 wherein the one or more notches have a cross-sectional profile selected from the group consisting of a U-shape, a V-shape, a rectangular profile, and combinations thereof.

12. A manufacturing apparatus for making a vehicular panel with a region of weakness that permits the panel to deform at predefined locations in a prescribed manner in response to an incidence force that strikes the panel, the panel having a substrate with an exposed surface (“A”) side, a hidden surface (“B”) side, and a core section extending therebetween, the manufacturing apparatus comprising:
a holding fixture that secures the “A” surface of the part; and
a means for scoring the “B” surface to define a scored part with one or more notches that extend inwardly from the “B” surface at least partially into the core section so that the one or more notches are invisible when viewed from the “A” side of the part; and
means for retracting the means for scoring so that the means for scoring can be removed from the scored part before the scored part is removed from the fixture.

13. The manufacturing apparatus of claim 12 wherein the means for scoring is an ultrasonic tool.

14. The manufacturing apparatus of claim 12 wherein the means for scoring applies a mechanical force to the part.

15. The manufacturing apparatus of claim 14 wherein the means for scoring defines a notch having a depth which is between 10% and 90% of the thickness of the panel.
